(19) United States
(12) Patent Application Publication
(10) Pub. No.: US 2003/0193889 A1
(43) Pub. Date: Oct. 16, 2003

(54) Wireless device and method for interference and channel adaptation in an OFDM communication system

(75) Inventor: Eric A. Jacobsen, Scottsdale, AZ (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/122,513

(22) Filed: Apr. 11, 2002

(51) Int. Cl. H04J 11/00

(52) U.S. Cl. 370/208; 370/204

(57) ABSTRACT

A wireless communication device communicates orthogonal frequency division multiplexing (OFDM) signals comprised of orthogonal subcarriers within an available spectrum. In-band interference, noise and channel effects may be measured for the subcarrier frequencies and a modulation order is selected on a per subcarrier basis to compensate for channel effects and in-band interference. Accordingly, the subcarriers may be configured to operate at a maximum communication rate allowing the channel to approach its “water-filling capacity”. In one embodiment, an access point may select modulation orders on a per subcarrier basis for upstream communications received from the wireless communication devices. In another embodiment, the wireless communication devices may select modulation orders on a per subcarrier basis for downstream communications received from the access point. Forward error correction (FEC) code rates and interleaving may be adjusted to the per subcarrier modulation selections.

### TECHNICAL FIELD

The present invention pertains to wireless communications, and in particular to orthogonal frequency division multiplexed communications.

### BACKGROUND

Orthogonal frequency division multiplexing (OFDM) is a multi-carrier transmission technique that uses orthogonal subcarriers to transmit information within an available spectrum. Because the subcarriers are orthogonal to one another, they may be spaced much more closely together within the available spectrum than, for example, the individual channels in a conventional frequency division multiplexing (FDM) system. An OFDM system may achieve orthogonality by using subcarriers that have a null at the center frequency of the other subcarriers. The orthogonality of the subcarriers may help prevent inter-subcarrier interference within the system. Before transmission, the subcarriers may be modulated with a low rate data stream. The transmitted symbol rate of the OFDM system is low, and thus the transmitted OFDM signal may be highly tolerant to multipath delay spread within the channel. For this reason, many modem digital communication systems are turning to OFDM as a modulation scheme for signals that need to survive in environments having multipath reflections and/or strong interference. Many wireless communication standards have already adopted OFDM including, for example, the IEEE 802.11a standard, the Digital Video Broadcasting Terrestrial (DVB-T) broadcasting standard, and the High performance radio Local Area Network (HiperLAN) standard. In addition, several industry consortia, including the Broadband Wireless Internet Forum and the OFDM Forum, are proposing OFDM for fixed wireless access systems.

One problem with conventional OFDM systems is that it is difficult to make efficient use of the channel due to in-band interference and channel effects (e.g., multipath reflections/frequency selective fading). These dynamically changing channel characteristics, for example, reduce the number of bits per symbol that can be effectively communicated. Conventional OFDM systems use equalization schemes to compensate for channel effects by applying equalization coefficients to the received signal to improve the likelihood of accurate detection. Although conventional equalization schemes may allow an OFDM channel to operate at a higher data rate, they do not allow an OFDM channel to reach its “water-filling capacity” because they do not take into account channel conditions on a per subcarrier basis. Furthermore, conventional OFDM equalization schemes do not take into account channel conditions, such as in-band interference, in only portions of the channel bandwidth.

Thus there is a general need for an improved OFDM communication system and method that allows an OFDM channel to approach its “water-filling capacity”.

### BRIEF DESCRIPTION OF THE DRAWINGS

The appended claims are directed to some of the various embodiments of the present invention. However, the detailed description presents a more complete understanding of the present invention when considered in connection with the figures, wherein like reference numbers refer to similar items throughout the figures and:

FIG. 1 is a wireless communication environment illustrating the operation of an embodiment of the present invention;

FIG. 2 is a highly simplified functional block diagram of a wireless communication device in accordance with an embodiment of the present invention;

FIG. 3 is a functional block diagram of a wireless communication device in accordance with an embodiment of the present invention;

FIG. 4A is a simplified timing diagram suitable for use by a point-to-multipoint communication system in accordance with an embodiment of the present invention;

FIG. 4B is a simplified timing diagram suitable for use by a point-to-point communication system in accordance with another embodiment of the present invention;

FIG. 5 is an example of channel response and interference in accordance with an embodiment of the present invention; and

FIGS. 6A and 6B are a flow chart of an interference and channel adaptation procedure in accordance with an embodiment of the present invention.

### DETAILED DESCRIPTION

The following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents.

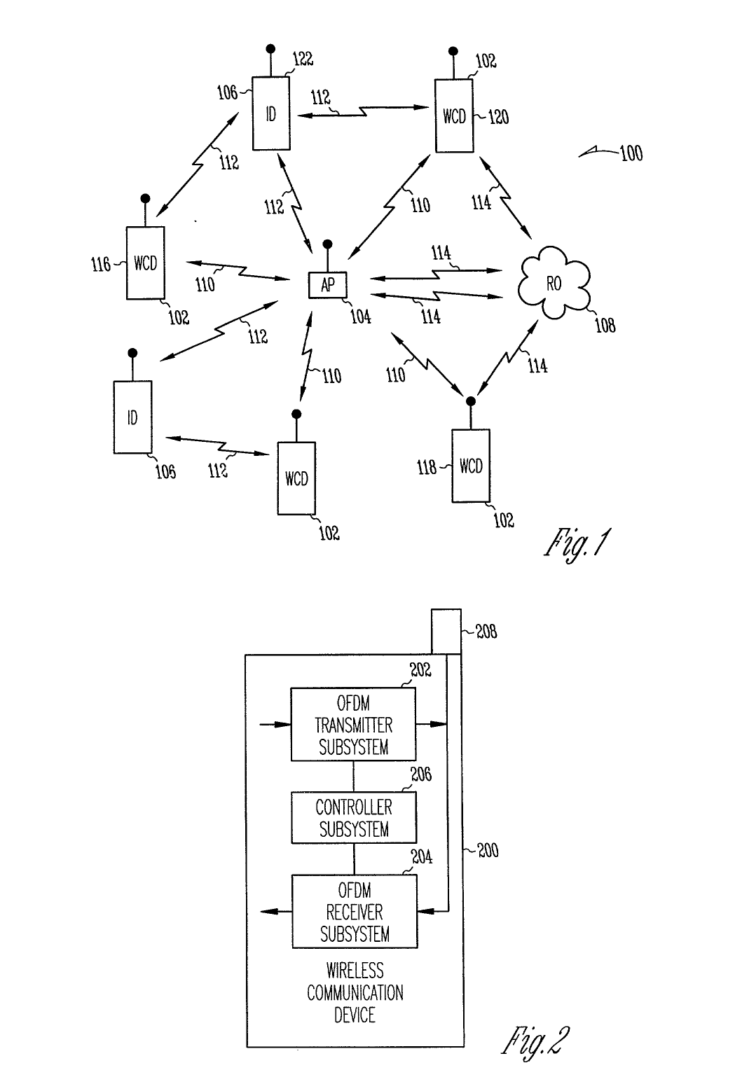

FIG. 1 is a wireless communication environment illustrating the operation of an embodiment of the present invention. Communication environment 100 includes one or more wireless communication devices (WCD) 102 which may communicate with access point (AP) 104 over communication bi-directional OFDM links 110. WCDs 102 may include, for example, personal digital assistants (PDAs), laptop and portable commuters with wireless communication capability, web tablets, wireless telephones, wireless headsets, pagers, instant messaging devices, MP3 players, digital cameras, and other devices that may receive and/or transmit information wirelessly. WCDs 102 may communicate with AP 104 using a multi-carrier transmission technique, such as an orthogonal frequency division multiplexing (OFDM) technique, that uses orthogonal subcarriers to transmit information within an assigned spectrum. WCDs 102 and AP 104 may also implement one or more communication standards, such as the IEEE 802.11a standard, the Digital Video Broadcasting Terrestrial (DVB-T) broadcasting standard, and the High performance radio Local Area Network (HiperLAN) standard.

In addition to facilitating communications between WCDs 102, in one embodiment AP 104 may be coupled with one or more networks, such as an intranet or the Internet, allowing WCDs 102 to access such networks. For convenience, the term downstream is used herein to designate communications in the direction from AP 104 to WCDs 102 while the term upstream is used herein to designate communications in the direction from WCDs 102 to AP 104, however, the terms downstream and upstream may be interchanged. In one embodiment, upstream and downstream communications may be time division multiplexed (TDM), although this is not a requirement. In another embodiment, downstream communications may be broadcast to more than one of WCDs 102 and may be frequency division multiplexed (FDM). WCDs 102 may support duplex communications utilizing different spectrum for upstream and downstream communications, although this is not a requirement. In one embodiment, upstream and downstream communications may share the same spectrum for communicating in both the upstream and downstream directions. Although FIG. 1 illustrates point-to-multipoint communications, embodiments of the present invention are suitable to both point-to-multipoint and point-to-point communications.

Communication environment 100 may also include one or more reflecting objects (RO) 108 which may cause multipath reflections and frequency selective fading within the spectrum utilized by AP 104 and WCDs 102. Communication environment 100 may also include one or more in-band interfering devices (ID) 106 which generate interference within the spectrum utilized by AP 104 and WCDs 102. Due to reflecting objects 108 and interfering devices 106, WCD 102 and AP 104 may experience channel fading, multipath components, and interference conditions unique to the particular WCD. WCDs 102 and AP 104 may adapt to the local channel conditions to achieve improved communication rates. For example, WCD 116 may compensate, at least in part, for in-band interference caused by interfering devices 106 to achieve an improved communication rate. WCD 118, for example, may compensate, at least in part, for multipath components caused by reflecting object 108 to achieve an improved communication rate. WCD 120, for example, may compensate, at least in part, for multipath components caused by reflecting object 108 and for in-band interference caused by interfering device 122 to achieve an improved communication rate. AP 104, for example, may adapt its communications with WCDs 102 to compensate for the conditions unique to the particular WCD to achieve an improved communication rate with WCDs 102.

In accordance with one embodiment, background noise, in-band interference and channel effects may be measured for portions of the assigned spectrum and a modulation order is selected on a per subcarrier basis to compensate for channel effects and in-band interference. Accordingly, the subcarriers may operate at different communication rates allowing the channel to approach its “water-filling capacity”. In one embodiment, AP 104 may select modulation orders on a per subcarrier basis for upstream communications received from WCDs 102. In another embodiment, WCDs 102 may select modulation orders on a per subcarrier basis for downstream communications received from AP 104. In one embodiment, forward error correction (FEC) code rates may be adjusted based on the per subcarrier modulation selections. In another embodiment, the FEC code rates may be adjusted and applied to all subcarriers in a group of OFDM symbols. The FEC code rate may be adapted, for example, by puncturing, shortening or selectively erasing the code. In accordance with yet another embodiment, an interleaving scheme may also be adjusted based on the per subcarrier modulation selections to match OFDM symbol boundaries. In another embodiment, the interleaving scheme may be adjusted and applied to all subcarriers in a group of OFDM symbols.

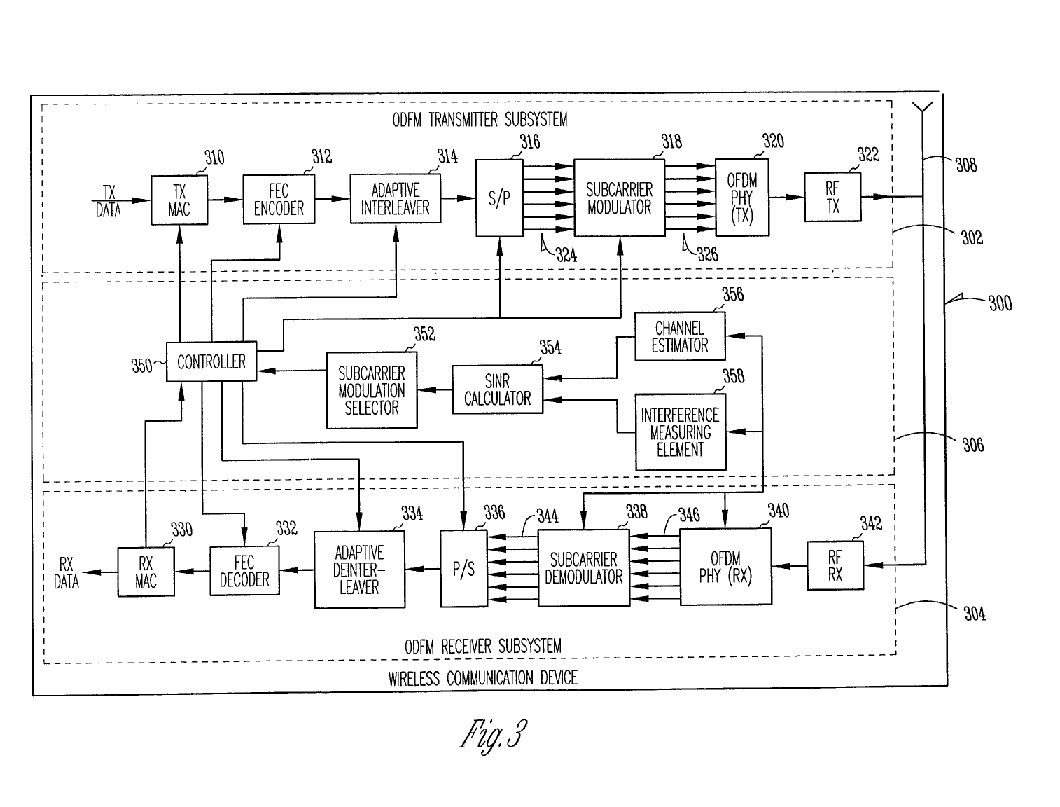

FIG. 2 is a highly simplified functional block diagram of a wireless communication device in accordance with an embodiment of the present invention. WCD 200 may be suitable for use as WCD 102 (FIG. 1) although other devices are also suitable. With the addition of a network communication interface, among other things, WCD 200 may also be suitable for use as access point 104 (FIG. 1) although other devices are also suitable. WCD 200 includes OFDM transmitter subsystem 202, OFDM receiver subsystem 204 and controller subsystem 206. WCD 200 may include other functional elements that are not illustrated that allow it to serve a primary purpose, such as operating as a PDA, a laptop or portable computer with wireless communication capability, a web tablet, a wireless telephone, a wireless headset, a pager, an instant messaging device, an MP3 player, a digital camera, or other device that may receive and/or transmit information wirelessly.

In accordance with one embodiment, controller subsystem 206 measures background noise, in-band interference and/or channel effects for portions of the spectrum and selects a modulation order on a per subcarrier basis to compensate for the channel effects and/or in-band interference. WCD 200 may transmit the selected modulation orders to another WCD, such as AP 104 (FIG. 1). The modulation orders may be used by the other WCD in transmitting downstream signals to WCD 200. Receiver subsystem 204 may use the selected modulation orders to demodulate the subcarriers for receiving downstream communications from the other WCD.

In one embodiment, WCD 200 may transmit a channel sounding preamble to allow the other WCD to measure the channel. The other WCD, such as AP 104 (FIG. 1), may select modulation orders for each subcarrier based on the channel measurements and/or in-band interference and background noise, and may transmit the selected per subcarrier modulation orders to WCD 200. Transmitter subsystem 202 may use the received modulation orders to modulate the subcarriers for upstream communications transmitted to the other WCD.

In one embodiment, the selection of modulation orders may be performed as often as the channel conditions change, depending on the coherence time of the channel. The channel conditions may be continually monitored and modulation orders may be selected when channel conditions change. Modulation orders may also be selected on a regular basis that may be less than the channel's coherence time.

In one embodiment, modulation orders may be selected based on a signal to interference and noise ratio (SINR). Higher modulation orders may be selected for subcarriers having better SINRs. Modulation orders define a number of bits per symbol that may be communicated using a particular subcarrier. Modulation orders may include binary phase shift keying (BPSK), which communicates one bit per symbol, quadrature phase shift keying (QPSK), which communicates two bits per symbol, 8PSK, which communicates three bits per symbol, 16-quadrature amplitude modulation (16-QAM), which communicates four bits per symbol, 32-QAM, which communicates five bits per symbol, and 64-QAM, which communicates six bits per symbol. Modulation orders may also include differentially coded star QAM (DSQAM). Modulation orders with lower and even higher communication rates per subcarrier may also be selected.

Accordingly, in a system that utilizes a channel comprised of a plurality of subcarriers, one or more of the subcarriers may utilize, for example, BPSK where there is a low SINR. One or more of the subcarriers may utilize a higher modulation order, such as 16-QAM for higher SINRs, and one or more of the subcarriers may utilize modulation orders of 64-QAM for even higher SINRs. Operating the subcarriers at different communication rates allows the channel to approach its “water-filling capacity” and allows the WCDs may adapt to in-band interference as well as channel fading.

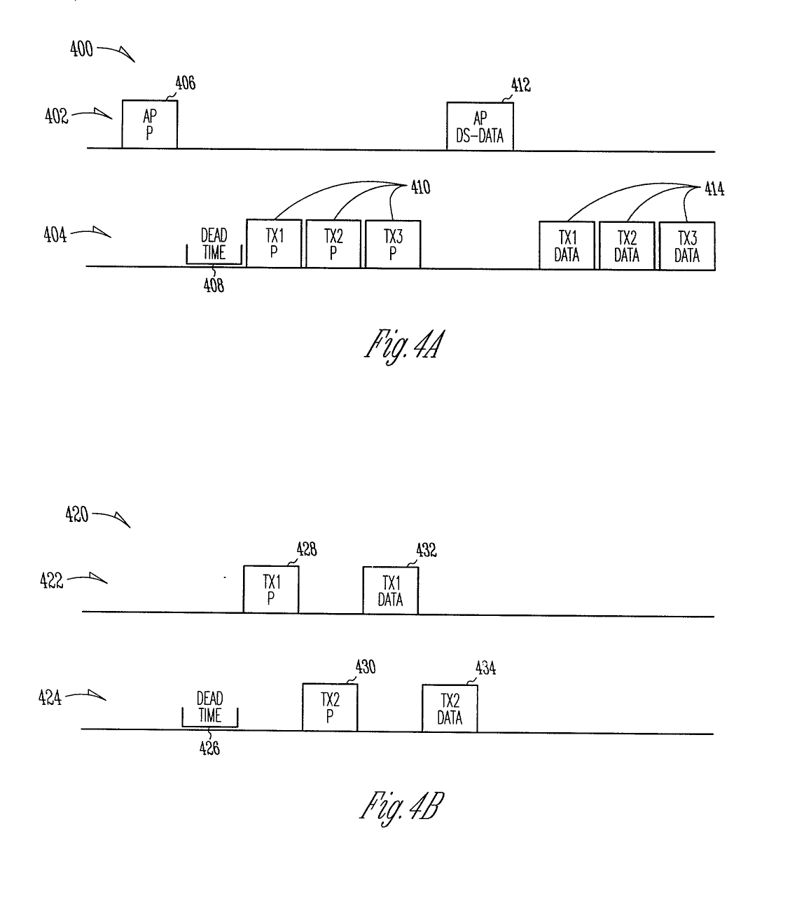

FIG. 3 is a functional block diagram of a wireless communication device in accordance with an embodiment of the present invention. WCD 300 may be suitable for use as WCD 102 (FIG. 1) and WCD 200 (FIG. 2) although other devices are also suitable. With the addition of a network communication interface, among other things, WCD 300 may also be suitable for use as access point 104 (FIG. 1) although other devices are also suitable. WCD 300 includes OFDM transmitter subsystem 302 which may correspond with OFDM transmitter subsystem 202 (FIG. 2), OFDM receiver subsystem 304 with may correspond with OFDM receiver subsystem 204 (FIG. 1), and controller subsystem 306 which may correspond with controller subsystem 206 (FIG. 2). WCD 300 may also include antenna 308, which may be, for example, a dipole antenna, monopole antenna loop antenna, microstrip antenna or other type of antenna. WCD 300 may include other functional elements that are not illustrated to allow WCD 300 to serve a primary purpose.

Transmitter subsystem 302 may include transmit media access controller (TX MAC) 310, FEC encoder 312, adaptive interleaver 314, serial to parallel (S/P) converter 316, subcarrier modulator 318, OFDM physical layer element (PHY) 320 and radio frequency transmitter (RF TX) 322. TX MAC 310 receives data in the form of a stream comprised of bits to be transmitted, FEC encoder 312 applies forward error correcting codes to the stream and adaptive interleaver 314 applies an interleaving scheme to the stream. S/P converter 316 converts the stream to parallel symbols 324. In one embodiment, S/P converter 316 may select a constellation point from the modulation order identified for that subcarrier, given the proper number of bits for that subcarrier. In an alternate embodiment, modulator 318 may perform this function. Subcarrier modulator 318 modulates parallel input symbols 324 to generate symbol-modulated subcarriers 326 for transmission. Subcarrier modulator 318 may use input symbols 324 to modulate a corresponding one of the subcarriers to generate symbol-modulated subcarriers 326. Subcarriers 326 of the OFDM system may be substantially orthogonal to each other to reduce inter-subcarrier interference. Subcarrier modulator 318 may use a modulation order selected from any of a plurality of modulation orders to modulate the subcarriers using any one of the modulation orders. In one embodiment, controller subsystem 306 may provide the selected modulation orders to subcarrier modulator 318 and/or S/P 316.

Symbol modulated subcarriers 326 form a frequency domain representation of the OFDM symbol. Symbol-modulated subcarriers 326 are applied to an Inverse Fast Fourier transform (IFFT) element, which may be part of OFDM PHY 320, to generate a time domain representation of the OFDM symbol. The time domain representation of the OFDM symbol is comprised of a plurality of time domain samples. Any form of inverse discrete Fourier transform (IDFT) may be used to perform the inverse transform operation, however an IFFT operation may be more computationally efficient. The number of time domain samples generated by the IFFT element may be equal to the number of frequency components input thereto.

OFDM PHY 320 may convert the time domain samples generated by the IFFT operation, which may be in a parallel form, to a serial sample stream representing the OFDM symbol. OFDM PHY 320 may also add a cyclic extension (or guard interval) to reduce inter-symbol interference in the channel, which may be caused by the channel's memory (i.e., multipath reflections). OFDM PHY 320 may provide the serial OFDM symbols, including its corresponding cyclic extension, in a continuous symbol stream to RF TX 322.

RF TX 322 converts the OFDM symbol stream into a radio frequency signal for transmission into the wireless channel. To perform this function, RF TX 322 may include, for example, a digital to analog converter, a frequency conversion unit (e.g., an up converter), a power amplifier, and/or other equipments to generate an RF transmit signal. Antenna 308 transmits the RF transmit signal into the channel. It should be appreciated that other processing functionality, such as error coding circuitry, may also be included within OFDM transmitter subsystem 302.

OFDM receiver subsystem 304 includes receive media access controller (RX MAC) 330, FEC decoder 332, adaptive de-interleaver 334, parallel to serial (P/S) converter 336, subcarrier demodulator 338, OFDM physical element (PHY) 350 and radio frequency receiver (RF RX) 342. Antenna 308 receives an RF communication signal from the channel. RF RX 342 converts the received RF signal to a format for subsequent processing. RF RX 342 may include, for example, a low noise amplifier, one or more frequency conversion units (e.g., a down converter), an analog to digital converter, and/or other functionality to achieve a desired signal format. RF RX 342 provides the signal to OFDM PHY 340. OFDM PHY 340 may include a synchronization element to synchronize the signal in a manner that allows the individual OFDM symbols within the signal to be recognized and the cyclic extensions to be discarded. The OFDM symbols, in a serial format, are converted into a parallel group of time domain samples. The samples are input into a Fast Fourier transform (FFT) element that may be part of OFDM PHY 340, to generate frequency domain symbol modulated subcarriers 346.

Subcarrier demodulator 338 demodulates symbol-modulated subcarriers 346 to produce symbols 344. In one embodiment, subcarrier demodulator 338 may demodulate symbol-modulated subcarriers 346 in accordance with a modulation order provided by controller subsystem 306. The modulation orders may have been selected by WCD 300 and provided to the WCD transmitting the received RF communication signal. WCD 300 may have selected the modulation orders based on channel conditions, such as background noise, in-band interference and/or channel response.

Parallel to serial converter 336 converts symbols 344 from a parallel form to a serial stream based on the selected modulation orders, adaptive de-interleaver 334 may perform a deinterleaving operation on the serial stream, and FEC decoder 332 may decode the serial stream. Receive media access controller (RX MAC) 330 receives the decoded serial bit stream and provides it to another portion of WCD 300, such as a system processor, for subsequent use.

Controller subsystem 306 may include controller 350, subcarrier modulation order selector 352, signal to interference and noise (SINR) calculator 354, channel estimator 356 and interference measuring element 358. In one embodiment, channel estimator 356 may generate a channel estimate of a downstream OFDM communication channel. The channel estimate may comprise a channel response across the channel bandwidth, and may be measured based on a channel sounding preamble transmitted by another WCD, such as AP 104 (FIG. 1). The channel sounding preamble may substantially occupy the entire downstream channel bandwidth. The channel estimate generated by channel estimator 356 may include a channel estimate for each subcarrier frequency.

Interference measuring element 358 measures interference within the downstream channel. The interference may include an interference level measured for each subcarrier frequency. In one embodiment, interference measuring element 358 may measure in-band interference during a period when communication devices of the system are instructed to refrain from transmitting (i.e., during a pre-designated dead time) allowing element 358 to measure in-band interference produced by non-system devices and noise levels.

SINR calculator 354 may calculate one or more parameters for use by subcarrier modulation selector 352 in selecting modulation orders. For example, SINR calculator 354 may use the channel estimate generated by channel estimator 356 and the interference measured by element 358 to calculate a SINR. In one embodiment, SINR calculator 354 may calculate a SINR for each subcarrier frequency of the downstream channel. In other embodiments, SINR calculator 354 may calculate other parameters based on background noise, in-band interference and/or channel effects for one or more subcarriers. The parameters may be used by subcarrier modulation selector 352 to select modulation orders for one or more of the subcarriers for use in demodulating received communications.

Controller 350, among other things, may receive the selected modulation orders from modulation selector 352 and may encode the selected modulation orders in a data message for TX MAC 310 for transmission to the other WCD. The other WCD may decode the data message, and use the selected modulation orders in transmitting downstream data to WCD 300 on the OFDM downstream channel. Controller 350 may also instruct subcarrier demodulator 338 to demodulate subcarriers in accordance with the selected modulation orders, which may be used by the other WCD for transmission.

In one embodiment, the decoded serial bit stream received by WCD 300 may include modulation orders selected by another WCD, such as AP 104 (FIG. 1) for use by WCD 300 in transmitting upstream communication signals. In this embodiment, controller 350 may interpret the decoded serial bit stream received from RX MAC 330 and provide the modulation orders to subcarrier modulator 318 for use in modulating subcarriers for transmission to the other WCD. Controller 350 may provide modulation orders for use in individually modulating one or more of the subcarriers of the upstream OFDM communication channel.

One consequence of the dynamic adaptation of the modulation density in each portion of the spectrum is the difficulty in matching constant-length FEC blocks to OFDM symbol boundaries. Since the number of coded bits transmitted in an OFDM symbol or group of symbols may change between frames due to modulation adaptation, the FEC and interleaving may change as well. In one embodiment of the present invention, controller 350 may adjust the FEC code rate applied by FEC encoder 312 and/or modify the interleaving applied by adaptive interleaver 314. In this embodiment, parameters for adjustment of the FEC code rate and/or modification of the interleaving for upstream communications may be determined by the other WCD and may be based on the modulation orders for the subcarriers selected by the other WCD for upstream communications. In one embodiment of the present invention, controller 350 may adjust the FEC code rate applied by FEC decoder 332 and/or modify the deinterleaving applied by adaptive de-interleaver 334. In this embodiment, parameters for adjustment of the FEC code rate and/or modification of the interleaving for downstream communications may be determined by controller 350 and may be based on the selected modulation orders for the subcarriers. The parameters for adjustment of the FEC code rate and/or modification of the interleaving may be transmitted to the other WCD for use in transmitting downstream communications to WCD 300. In these embodiments, the adjustment of the FEC code rate may include the use of puncturing, shortening and/or erasing the code. Also in these embodiments, the interleaving scheme may be adapted to match the OFDM symbol boundaries considering the selected per-subcarrier modulation orders. For example, continuous interleaving methods, such as helical interleaving, may be adjusted by zero padding up to the nearest symbol boundary. Random interleaving may be accomplished by storing multiple random interleaver configurations and using a best fit interleaver with small adjustments by zero padding to the nearest symbol boundary. Analytically generated interleaving patterns specific to each configuration may also be generated.

Although WCD 300 is illustrated in FIG. 3 as having separate functional transmitter, receiver and controller subsystems, one or more of the functional elements of these subsystems may be combined and may be implemented by combinations of software configured elements and/or hardware. For example, TX MAC 310 and RX MAC 330 may be implemented by one functional element, and a software-configured processor may implement one or more of the functional elements of controller subsystem 306. Although WCD 300 is illustrated with interleaver 314 and de-interleaver 334, these functional elements, among others, are optional and several of the embodiments of the present invention may be implemented without requiring interleaving.

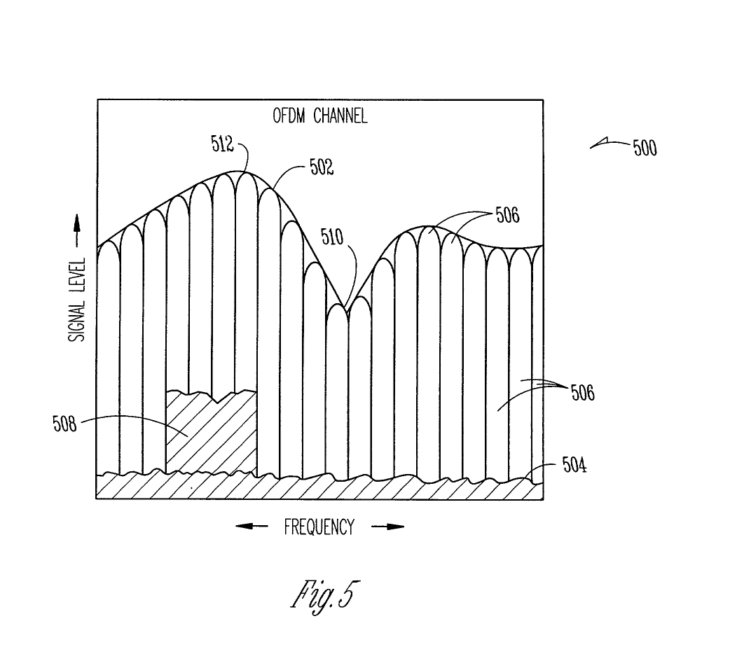

FIG. 4A is a simplified timing diagram suitable for use by a point-to-multipoint communication system in accordance with an embodiment of the present invention. Timing diagram 400 illustrates access point transmission 402 and terminal transmissions 404. Access point (AP) transmissions 402 may be transmitted by a WCD such as AP 104 (FIG. 1) and terminal transmissions 404 may be transmitted by WCDs 102 (FIG. 1) although other devices may also be suitable. Timing diagram 400 is an example of one embodiment in which AP point may provide point-to-multipoint communications with one or more WCDs. The AP transmits channel sounding preamble 406 which may be used by one or more WCDs to measure the channel. Subsequent to channel sounding preamble 406 may be dead time 408 wherein WCDs may refrain from transmitting. The WCDs may refrain from transmitting during dead time 408 in response to channel sounding preamble 406 received from the AP. The WCDs, including the AP, may measure in-band interference and noise levels at their location during dead time 408. The WCDs may use the in-band interference and channel measurements to select communication parameters including modulation orders, FEC codes and/or an interleaving scheme, for subsequent use by the AP. Following dead time 408, the WCDs may sequentially transmit channel sounding preambles 410 to the AP.

In one embodiment, the WCDs may transmit its selected communication parameters prior to, as part of, or subsequent to the transmission of channel sounding preambles 410. The AP may use the channel sounding preambles 410 to measure the upstream channel conditions, which may differ for each WCD. The AP may select communication parameters for the WCDs based on the in-band interference and noise levels measured during dead time 408 and channel conditions, which may be measured for each WCD. The AP may transmit downstream data 412 to the WCDs. In one embodiment, AP may use the communication parameters, which may be selected by a WCD in transmitting downstream data 412 to the WCD. Downstream data 412 may include modulation orders, FEC codes and/or interleaving selected by AP for use by a WCD. A WCD may utilize the communication parameters selected by AP to communicate upstream data 414. Accordingly, the parameters for communicating downstream data 412 may be configured for the downstream channel conditions, and the parameters for communicating upstream data 414 may be configured for the upstream channel conditions.

The framing duration illustrated in FIG. 4A may be shorter than the coherence time of the channel so that the AP and the WCDs are able to adapt to the environmental dynamics of the channel. In one embodiment, the AP may determine the channel coherence time to determine a frame rate at which to update the preamble handshakes (preambles 406, 410) illustrated in FIG. 4A.

FIG. 4B is a simplified timing diagram suitable for use by a point-to-point communication system in accordance with another embodiment of the present invention. Timing diagram 420 illustrates terminal transmissions 422 of a first WCD and terminal transmissions 424 of a second WCD. Terminal transmissions 422 and 424 may be transmitted by WCDs 102 (FIG. 1) although other devices may also be suitable. Timing diagram 420 is an example of one embodiment providing point-to-point communications between two or more WCDs. In accordance with this embodiment, in-band interference and noise levels may be measured during dead time 426 until the first WCD transmits channel sounding preamble 428. The second WCD may respond (i.e., handshaking) to channel sounding preamble 428 from the first WCD by transmitting channel sounding preamble 430. A WCD may use the channel sounding preamble received from the other WCD to measure the channel, and may select communication parameters for the subcarriers for use by the other WCD in transmitting data. The second WCD may include the communication parameters selected for the subcarriers with channel sounding preamble 430, while the first WCD may include the selected communication parameters with data transmissions 432. Accordingly, data 432 may be communicated through the channel in accordance with the communication parameters selected by the second WCD, and data 434 may be communicated through the channel in accordance with the communication parameters selected by the first WCD.

In the point-to-point embodiment, a WCD may transmit a preamble to initiate a data transfer. Other WCDs may respond to the preamble allowing the WCDs to determine communication parameters for transmitting to the other WCDs. In this embodiment, interference measurements may be made continuously or may be made periodically, such as during dead times when the channel is not being used for transmissions.

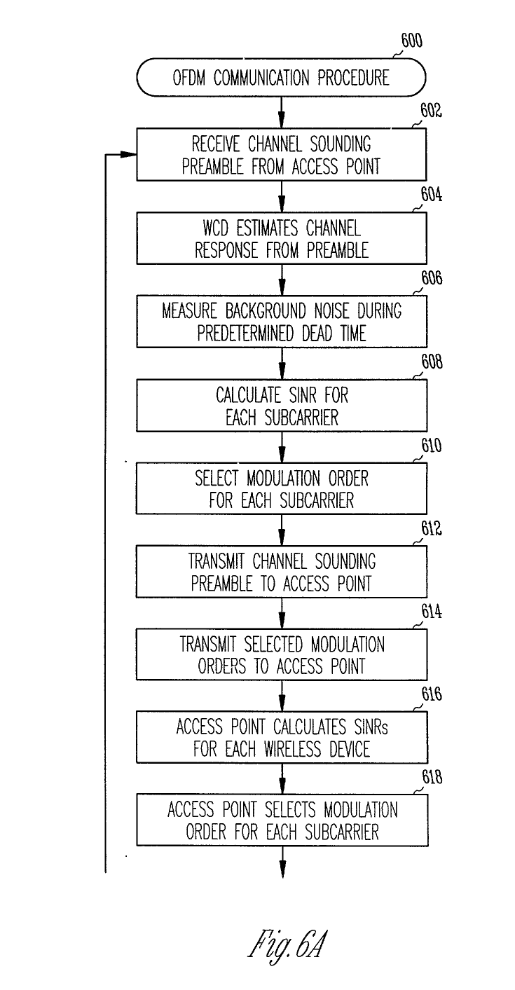

FIG. 5 is an example of channel response and interference of an OFDM channel in accordance with an embodiment of the present invention. OFDM channel 500 may be comprised of a plurality of subcarriers 506 and may have channel response 502 across the channel bandwidth as well as noise level 504. A WCD, such one of WCDs 102 (FIG. 1) or AP 104 (FIG. 1), may measure channel response 502 during a channel sounding preamble received from another WCD. Channel response 502 around point 510 illustrates particular frequencies within the channel having a low signal to noise ratio, while the channel response around point 512 illustrates particular frequencies within the channel having a high signal to noise ratio. As WCDs change location and as channel conditions change, channel response 502 may change. In-band interference 508 along with noise level 504 may be measured by WCDs during dead times. In-band interference 508 may come and go as in-band interfering devices transmit. In accordance with one embodiment, WCDs may calculate a signal to interference and noise level (SINR) at a subcarrier frequency. In the illustration of FIG. 5, the SINR is the difference between channel response 502 and either noise level 504 or the level of in-band interference 508. Subcarriers 506 are illustrated as having their communication parameters (e.g., modulation orders, FEC codes and/or an interleaving scheme) selected to approach the water-filled capacity of the channel. In other words, subcarrier 506 may be configured to communicate at a maximum rate based on the SINR at the subcarrier frequency. Conventional OFDM systems, on the other hand, use the same communication parameters for each subcarrier. Conventional OFDM systems also select the same communication parameters for all subcarriers based on the point having the worst channel response (i.e., point 510) and/or highest noise/interference level in the channel (interference 508). As can be appreciated, this conventional approach results in a much lower communication rate.

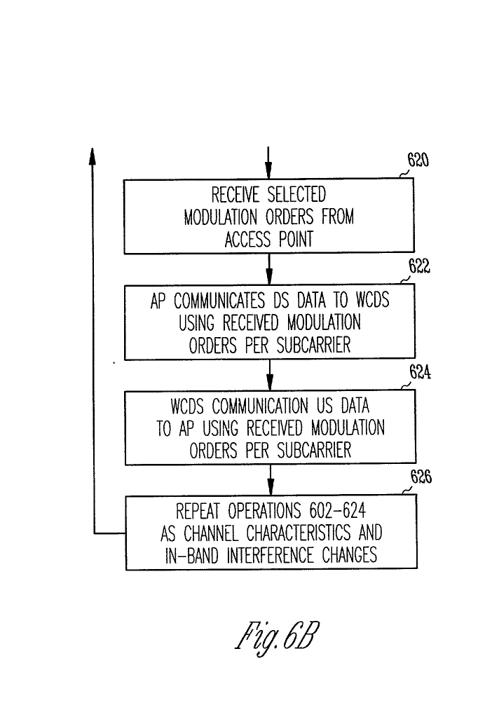

FIGS. 6A and 6B are a flow chart of an interference and channel adaptation procedure in accordance with an embodiment of the present invention. Procedure 600 may be performed by one or more WCDs such as WCDs 102 (FIG. 1) and AP 104 (FIG. 1) although other devices are also suitable. Through the performance of procedure 600, WCDs dynamically determine communication parameters for communication through an OFDM channel based on channel conditions that include in-band interference and channel response. Although the individual operations of procedure 600 are illustrated and described as separate operations, one or more of the individual operations may be performed concurrently and nothing requires that the operations be performed in the order illustrated. Although procedure 600 is described for point-to-multipoint embodiments, it may be equally applicable to point-to-point embodiments of the present invention.

In operation 602, one or more WCDs receive a channel sounding preamble from an AP. The channel sounding preamble may by transmitted so as to evenly occupy the entire channel bandwidth. The channel sounding preamble may be considered a burst. In operation 604, the one or more WCDs estimate a channel response from the received channel sounding preamble. In operation 604, channel response may be measured for each subcarrier frequency. In operation 606, the WCDs and AP may measure the noise level including in-band interference during a dead time. In operation 606, the noise level and in-band interference may be measured for each subcarrier frequency. The dead time may follow the channel sounding preamble, may be at predesignated time, or may be at a time when no transmissions are occurring. In operation 608, parameters, such as a SINR, may be calculated for each subcarrier frequency from the channel response measurements of operation 604 and measurements from operation 606.

In operation 610, the one or more WCDs may calculate channel communication parameters for each subcarrier. The channel communication parameters may include modulation orders, FEC codes and/or an interleaving scheme for each subcarrier. In operation 612, the one or more WCDs may transmit a channel sounding preamble to the AP. In the point-to-multipoint embodiments the channel sounding preambles may be transmitted sequentially by the WCDs. In response to channel sounding preambles, the AP may determine the channel response of the channel with each WCD. Due to the different locations of the WCDs, the channel response may be different for each WCD. In operation 614, the WCDs may transmit the communication parameters selected in operation 610 to the AP. Operation 614 may be performed as part of operation 612. In transmitting communication parameters to the AP, a predetermined modulation order, FEC coding rate and interleaving scheme may be used. The predetermined modulation order may be a lower modulation order, such as BPSK.

In operation 616, the AP may calculate parameters, such as SINRs, for each subcarrier frequency based on the interference measured in operation 606 and based on the channel conditions measured for each WCD in operation 612. In operation 618, the AP may select channel communication parameters for each subcarrier of each of the channels. In a point-to-multipoint system where the AP communicates with several WCDs, the AP may determine communication parameters for receiving communications from each of the WCDs. The channel communication parameters may include modulation orders, FEC codes and/or an interleaving scheme for each subcarrier. In operation 620, the WCDs receive the selected communication parameters from the AP. In transmitting the communication parameters to the WCDs, a predetermined modulation order, FEC coding rate and interleaving scheme may be used by the AP. The predetermined modulation order may be a lower modulation order, such as BPSK.

In operation 622, the AP may communicate downstream data to the WCDs using the communication parameters received in operation 614. In operation 624, the WCDs may communicate upstream data to the AP using the communication parameters received in operation 620. In operation 626, operations 602 through 624 may be repeated. Operation 626 may be performed on a regular basis, which may be less than the coherence time of the channel so as to respond to changes in channel conditions. In one embodiment, the coherence time of the channel may be dynamically determined based on channel measurements. Operation 626 may be performed when channel conditions change.

Thus, a wireless communication device and method have been described that provide a more efficient use of an OFDM communication channel. In-band interference and channel effects may be measured for each portion of the spectrum and a modulation order may selected on a per subcarrier basis to compensate, at least in part for channel effects and in-band interference. Accordingly, the subcarriers may operate at different communication rates allowing the channel to approach its “water-filling capacity”. In one embodiment, an access point may select modulation orders on a per subcarrier basis for upstream communications received from each of a plurality of wireless communication devices. In another embodiment, the wireless communication devices may select modulation orders on a per subcarrier basis for downstream communications received from the access point. In other embodiments, forward error correction (FEC) code rates and interleaving may be adjusted to the per subcarrier modulation selections.

The foregoing description of specific embodiments reveals the general nature of the invention sufficiently that others can, by applying current knowledge, readily modify and/or adapt it for various applications without departing from the generic concept. Therefore such adaptations and modifications are within the meaning and range of equivalents of the disclosed embodiments. The phraseology or terminology employed herein is for the purpose of description and not of limitation. Accordingly, the invention embraces all such alternatives, modifications, equivalents and variations as fall within the spirit and scope of the appended claims.

What is claimed is:

1. A method to communicate over an orthogonal frequency division multiplexed (OFDM) communication channel comprising:
selecting a modulation order for a plurality of subcarrier frequencies; and
receiving communications from a wireless communication device on the plurality of subcarrier frequencies in accordance with the selected modulation orders.

2. The method of claim 1 further comprising transmitting the selected modulation orders to the wireless communication device, and
wherein selecting a modulation order comprises selecting the modulation order for at least one of the subcarrier frequencies based on a signal to noise and interference ratio (SINR) associated with the selected subcarrier frequency.

3. The method of claim 2 further comprising measuring channel characteristics and background noise levels for the at least one of the subcarrier frequencies to determine the SINR for the at least one subcarrier frequency across a channel bandwidth.

4. The method of claim 3 wherein measuring channel characteristics comprises receiving a channel sounding preamble from the wireless communication device, the channel sounding preamble occupying substantially the channel bandwidth.

5. The method of claim 3 wherein measuring background noise levels comprises measuring a background noise level for the subcarrier frequencies across the channel bandwidth during a period when system devices including the wireless communication device refrain from transmitting.

6. The method of claim 5 wherein measuring background noise levels includes measuring in-band interference at the subcarrier frequencies.

7. The method of claim 4 wherein the channel sounding preamble is an downstream channel sounding preamble and the plurality of subcarrier frequencies are downstream subcarrier frequencies, and
wherein the method further comprises transmitting an upstream channel sounding preamble to the wireless communication device, the wireless communication device selecting a modulation order for upstream communications for the upstream subcarrier frequencies based on upstream channel characteristics determined from the upstream channel sounding preamble and based on the background noise levels.

8. The method of claim 7 further comprising:
receiving the modulation orders selected for upstream communications from the wireless communication device; and
transmitting communications to the wireless communication device on the plurality of upstream subcarrier frequencies in accordance with the received modulations orders for the upstream subcarrier frequencies.

9. The method of claim 1 wherein the modulation orders include at least one of a BPSK, QPSK, 8PSK, 16-QAM, 32-QAM and 64-QAM, wherein a higher of the modulation orders is selected for subcarrier frequencies having greater SINRs.

10. The method of claim 1 wherein the wireless communication device is an access point in communication with a portable wireless communication device performing the selecting, transmitting and receiving.

11. The method of claim 1 wherein the wireless communication device is an access point in communication a plurality of portable wireless communication devices, at least one of the portable devices performing the selecting, transmitting and receiving, the access point transmitting communications to the at least one of the portable wireless communication devices in accordance with modulation orders for each subcarrier frequency selected by the at least one portable wireless communication device.

12. The method of claim 1 wherein the wireless communication device is a portable wireless communication device and an access point performs the selecting and receiving for the plurality of portable wireless communication devices.

13. The method of claim 1 further comprising adapting at least one of a forward error correcting (FEC) code rate and interleaving scheme based on the selected modulation orders.

14. A method comprising:
transmitting a channel sounding preamble to a wireless communication device, the channel sounding preamble occupying substantially a channel bandwidth of an orthogonal frequency division multiplexed (OFDM) communication channel which utilizes a plurality of subcarrier frequencies;
receiving a selected modulation order for at least one of the subcarrier frequencies from the wireless communication device; and
transmitting OFDM communications to the wireless communication device on the subcarrier frequencies in accordance with the selected modulation orders.

15. The method of claim 14 wherein the wireless communication device measures channel characteristics and background noise levels for the subcarrier frequencies to determine a signal to noise and interference ratio (SINR) for the subcarrier frequencies across the channel bandwidth, and selects the modulation order for the subcarrier frequencies based on the SINR associated with a particular subcarrier frequency.

16. The method of claim 15 wherein the wireless communication device measures the background noise level for the subcarrier frequencies across the channel bandwidth during a period when system devices including the wireless communication device refrain from transmitting.

17. The method of claim 15 wherein the wireless communication device also selects at least one of a forward error correcting (FEC) code rate and interleaving scheme based on the selected modulation orders, and transmits the selected at least one of the forward error correcting (FEC) code rate or the interleaving scheme along with the selected modulation orders to another wireless communication device.

18. A wireless communication device comprising:
a modulation order selector to select a modulation order for at least one subcarrier frequency of a plurality of subcarrier frequencies utilized by an orthogonal frequency division multiplexed (OFDM) communication channel; and
an OFDM receiver to receive communications from another wireless communication device on the plurality of subcarrier frequencies in accordance with the selected modulation orders.

19. The wireless communication device of claim 18 further comprising:
a transmitter to transmit the selected modulation orders to another wireless communication device;
a channel characteristic measuring element to measure channel characteristics for the subcarrier frequencies; and
a noise level measuring element to measure noise levels within the channel.

20. The wireless communication device of claim 19 further comprising a signal to noise and interference ratio (SINR) determining element to determine a SINR for the subcarrier frequencies across a channel bandwidth using the measured noise levels and the measured channel characteristics, wherein the modulation order selector selects the modulation order for the subcarrier frequencies based on the SINR associated with one of the subcarrier frequencies.

21. The wireless communication device of claim 19 wherein the receiver receives a channel sounding preamble from the other wireless communication device, the channel sounding preamble occupying substantially the channel bandwidth, and the channel characteristic measuring element measures channel characteristics for the subcarrier frequencies based on the channel sounding preamble.

22. The wireless communication device of claim 19 wherein the noise level measuring element measures the noise level for the subcarrier frequencies across the channel bandwidth during a period when system devices including the other wireless communication device refrain from transmitting.

23. The wireless communication device of claim 19 wherein the OFDM receiver includes a subcarrier demodulator to demodulate received communications using the selected modulation orders.

24. The wireless communication device of claim 23 wherein the OFDM receive further includes at least one of an adaptive de-interleaver and a forward error correcting (FEC) decoder.

25. The wireless communication device of claim 18 further comprising an OFDM transmitter, the transmitter including an adaptive subcarrier modulator to modulate the subcarrier frequencies in accordance with modulation orders received from the another wireless communication device.

26. The wireless communication device of claim 25 wherein the OFDM transmitter further includes at least one of an adaptive interleaver and a forward error correcting (FEC) encoder, the adaptive interleaver to implement an interleaving scheme based on the modulation orders received form the another wireless communication device, the FEC encoder to implement an FEC encoding rate based on the modulation orders received form the another wireless communication device.

27. A system comprising:
a modulation order selector to select a modulation order for at least one subcarrier frequency of a plurality of subcarrier frequencies utilized by an orthogonal frequency division multiplexed (OFDM) communication channel;
a dipole antenna to receive communications from another wireless communication device on the plurality of subcarrier frequencies; and
a receiver to demodulate the subcarrier frequencies in accordance with the selected modulation orders.

28. The system of claim 27 further comprising:
a transmitter to transmit the selected modulation orders to another wireless communication device;
a channel characteristic measuring element to measure channel characteristics for the subcarrier frequencies; and
a noise level measuring element to measure noise levels within the channel.

29. The system of claim 28 further comprising a signal to noise and interference ratio (SINR) determining element to determine a SINR for the subcarrier frequencies across a channel bandwidth using the measured noise levels and the measured channel characteristics, wherein the modulation order selector selects the modulation order for the subcarrier frequencies based on the SINR associated with one of the subcarrier frequencies.
